(19) United States
(12) Patent Application Publication
(10) Pub. No.: US 2020/0108518 A1
(43) Pub. Date: Apr. 9, 2020

(54) HOLDING CLIPS FOR SHEARS

(71) Applicant: Thomas Fountain, St. James (BB)

(72) Inventor: Thomas Fountain, St. James (BB)

(21) Appl. No.: 16/590,408

(22) Filed: Oct. 2, 2019

Related U.S. Application Data
(60) Provisional application No. 62/743,534, filed on Oct. 9, 2018.

(51) Int. Cl. B26B 29/04

(52) U.S. Cl. CPC B26B 29/04

(57) ABSTRACT

The present invention is a sheath structure for shears, comprising; shears having cutting blades and a pair of openings, a sheath, which has a first end and a second end, wherein the second end has a formed cavity, wherein the formed cavity is sized to receive the shears and the first end has a restraining means for preventing the shears from releasing from the sheath.

This application is a continuation (and claims the benefit of priority under 35 USC 120) of U.S. application No. 62/743,534 filed Oct. 9, 2018. The disclosure of the prior applications is considered part of (and is incorporated by reference in) the disclosure of this application.

### BACKGROUND OF THE INVENTION

Scissors, shears and similar cutting implements having two pivotally connected cutting blades (hereinafter referred to as “shears”) are sometimes provided with a sheath which protects the scissors blades while the scissors are stored or carried therein to thereby prevent dulling of the blades, to prevent injury to a user and to prevent damage to other objects. Such sheaths are usually constructed so as to prevent accidental or unintentional dislodgement or removal of the scissors from the sheath, while enabling intentional withdrawal.

A drawback of the commonly used sheaths is that they require various locking mechanism to keep the shears in place, or the sheath requires two hands to remove the shears from the sheath. This either increase the time required to remove the shears, or require full attention from the person when removing the shears. In instances where the shears need to be removed quickly, or the person needs a free hand, the present inventions are limited in these capacities. The invention improves the sheath design to be easy to insert, lock in place, and remove the shears with one hand.

### BRIEF SUMMARY OF THE INVENTION

In a first embodiment, the present invention is a sheath structure for shears, comprising: shears having cutting blades and a pair of openings; and a sheath, which has a first end and a second end, wherein the first end has a formed cavity, wherein the formed cavity is sized to receive the shears and the second end has a restraining means for preventing the shears from releasing from the sheath.

In a second embodiment, the present invention is a holster for carrying scissors, comprising: scissors having a pair of handle openings and cutting blades; and a holster including a first end and a second end, wherein the first end has a cavity, and the cavity has an opening designed to receive the cutting blades of the scissors, and the second end has a set of securing means designed to be received by at least one of the pair of handle openings.

In a third embodiment, the present invention is a holster for carrying shears, comprising: a holster, wherein the holster has a first end and a second end, the first end has a compartment designed to receive a cutting end of a pair of shears, and the second end has at least one protrusion designed to secure the pair of shears in place when the cutting end of the pair of shears are placed within the compartment.

### BRIEF DESCRIPTION OF THE SEVERAL VIEWS OF THE DRAWING

FIG. 1 depicts an illustration of a pair of shears, in accordance with one embodiment of the present invention.

FIG. 2 depicts an illustration of a sheath, in accordance with one embodiment of the present invention.

FIG. 3 depicts an illustration of a side view of the sheath, in accordance with one embodiment of the present invention.

FIG. 4 depicts an illustration of a pair of shears being inserted into the sheath, in accordance with one embodiment of the present invention.

FIG. 5 depicts an illustration of a pair of shears inserted into the sheath, in accordance with one embodiment of the present invention.

FIG. 6 depicts an illustration of an alternative design for the sheath and the shears, in accordance with one embodiment of the present invention.

FIG. 7 depicts an illustration of the alternative design for the shears inserted in the sheath, in accordance with one embodiment of the present invention.

FIG. 8 depicts an illustration of a sheath, in accordance with another embodiment of the present invention.

FIG. 9 depicts an illustration of the sheath, in accordance with another embodiment of the present invention.

### DETAILED DESCRIPTION OF THE INVENTION

The present invention provides a sheath (e.g. holster, carrier, pocket, etc.) that is designed to allow for easy insertion and remove of a pair of shears (e.g. scissors, clippers, etc.) with one hand. Based on the design of the shears, the sheath has a specific design to receive the shears with ease and allow for easily accessible releases for the shears. Other embodiments of the device have various clips and attachments to secure to various items and articles of clothing. The invention improves on existing designs of sheaths by making it possible to insert and remove the shears with only one hand using a simple and natural action.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, and as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

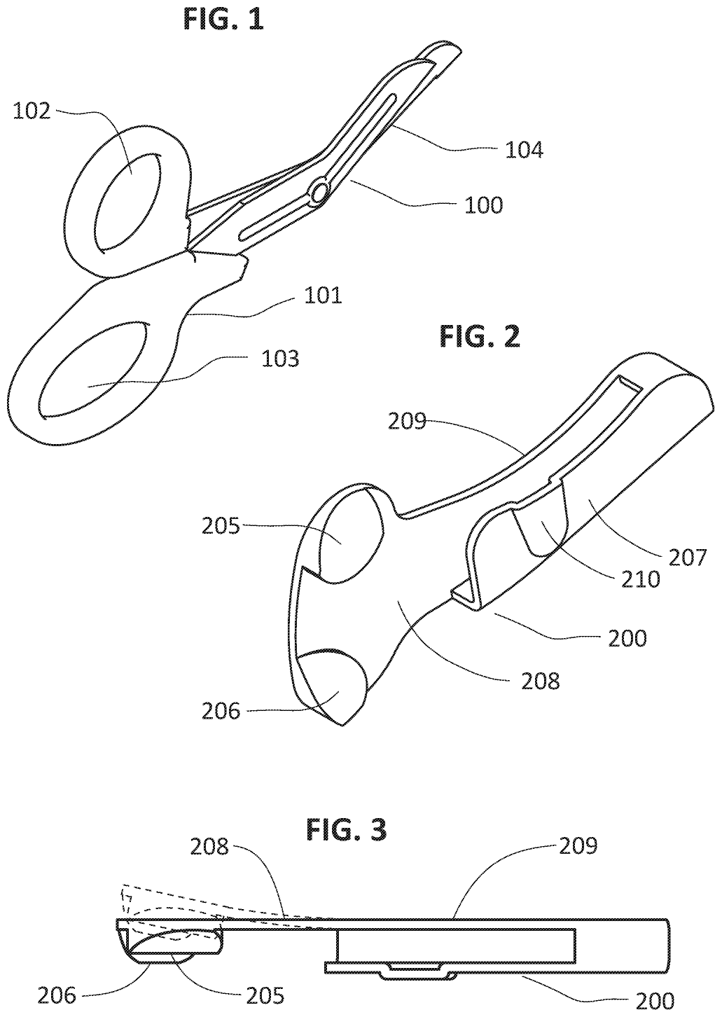

FIG. 1 depicts an illustration of a pair of shears 100, in accordance with one embodiment of the present invention. The depicted shears 100 are an example of one type of shears. Multiple different types of shears 100 may be used. The present set of shears 100 are typical trauma shears used by medical professionals. The shears 100 have two openings (e.g. finger inserts, finger rings, etc.) 102 and 103 attached to a handle 101 with blades 104 at the opposing end with a pivot point between the handle 101 and the blades 104.

FIG. 2 depicts an illustration of a sheath 200, in accordance with one embodiment of the present invention. The sheath 200 is comprised of a back plate 209 which extends a set length based on the type of shears 100. At a first end the cover 207 is used to protect the blades 104. In the depicted embodiment, a portion of the shears 100 are completed covered by the cover 207. In additional embodiments, a section of the blades 104 is exposed to allow for easer removal of the shears 100 from the sheath 200. At the opposite end as the cover 207 is a set of protrusions 5 and 206. The end (or spring plate) 208 of the back plate 209 near the protrusions 205 and 206 is able to deflect a predetermined distance from the “resting” position. The protrusions 205 and 206 have a predetermined shape, size, and configuration based on the openings 102 and 103 of the shears 100. In one embodiment, the exposed surface of the protrusions 205 and 206 is larger than that of a human thumb. In some embodiments, the exposed surface of the protrusions 5 and 206 has a texture or coating to increase the friction coefficient, thereby decreasing the likelihood of the person slipping their finger off the protrusion. The protrusions 205 and 206 are designed to “lock” or secure the shears 100 in the sheath 200. In the depicted embodiment, a groove 10 is incorporated into the cover 207, this is to allow for the pivot pin of the shears, which extend beyond the surface of the blades 104 to fit within the cover 207. The sheath 200 is made from a semi-rigid material such as various plastics, metals, and composite materials, known to one skilled in the art.

FIG. 3 depicts an illustration of a top view of the sheath 200, in accordance with one embodiment of the present invention. In the depicted figure, the protrusions 205 and 206 are shown deflected away from the back plate 209. The depth of the protrusions is, in one embodiment, deeper than the depth of the openings 102 and 103 of the shears. In the depicted illustration, the spring plate 208 is shown in a resting state, and in an activated state (dotted lines). Through a predetermined force (based on the material type, thickness, and rigidity), the spring plate 8 can be pushed, so that the protrusions 205 and 206 would not be obstructing the shears 100 and allow for unrestricted removal of the shears 100 from the sheath 100.

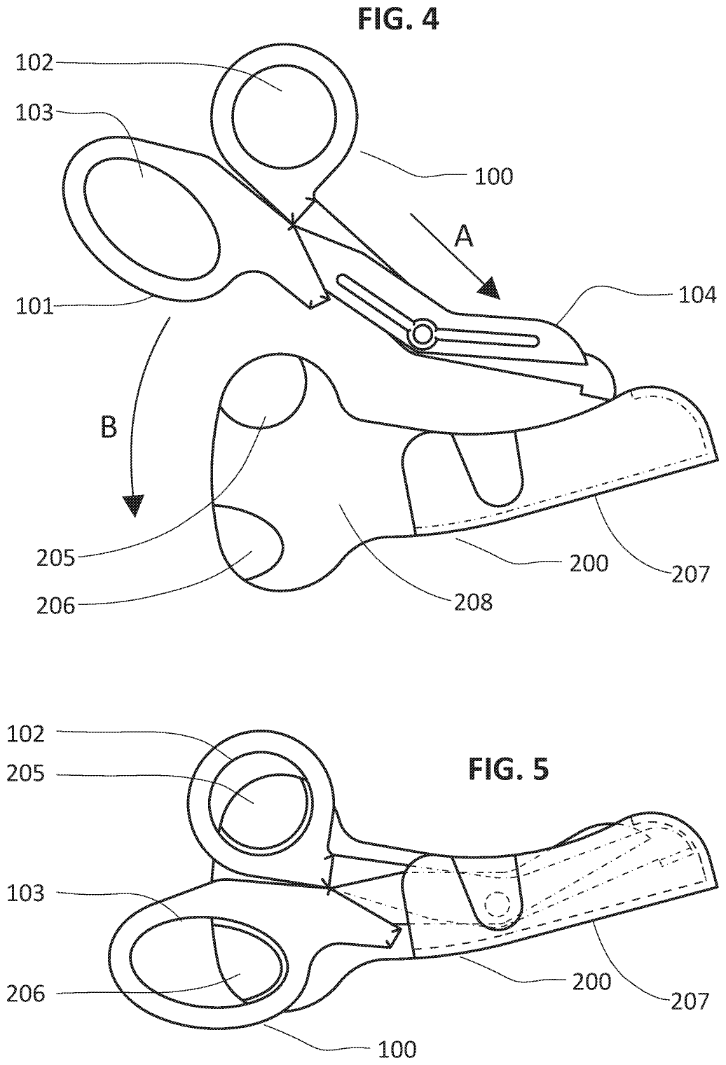

FIGS. 4 and 5 depict illustrations of the pair of shears 100 being inserted into the sheath 200, in accordance with one embodiment of the present invention. In the depicted embodiments, the protrusions 205 and 206 are made according to the size, position, contour, and shape of the openings 102 and 103 of the shears. This provides the advantage of securing the shears 100 in place and restricting movement of the shears 100 in any direction. The protrusions 205 and 206 are also designed to fill a predetermined volume of the openings 102 and 103. In some embodiments, the protrusions 205 and 206, substantially file the openings 102 and 103.

The method of inserting the shears into the sheath, the user starts by holding the shears normally, whereby the thumb is in the upper opening of the handle and the index and middle fingers are in the lower opening of the handle. During insertion the user withdraws their fingers and pushes the shears into the latch position, where the sprung protrusions on the holder latch into the openings of the shears. The shears are removed from the holder by placing the middle finger in the back of the lower opening and then using the thumb and index finger to press against the protrusion(s) on the device to release the shears.

FIG. 4 depicts the action used to insert the shears 100 into the sheath 200, where the user grips the shears 100 in the normal manner with their thumb in opening 102 and their index and middle fingers in opening 103. The user inserts the blades 104 of the shears 100 into the cover 207 of the sheath 200 as depicted by arrow A and, once the blades 104 have reached the end of the sheath 200, the shears 200 are then rotated down as depicted by arrow B whilst the user withdraws their fingers from the openings 102 and 103, and continues to push in the direction of arrow B causing the handle 1 of the shears 100 to deflect the protrusions 205 and 206 thereby allowing the shears 100 to bypass them until the shears reach the latch position, where the protrusions 205 and 206, return to their original position, back into the openings 2 and 3 to latch (lock) the shears 100 in place.

FIG. 5 depicts the shears 100 inserted into the sheath 200 where the protrusions 205 and 206 are latched into the openings 2 and 3. To remove the shears 100 from the sheath 200 the user places their middle finger in the back of opening 3, behind protrusion 206, whilst using their thumb and index finger to press against protrusions 205 and 206 thereby de-latching the shears 100 from the sheath 200 and allowing the shears 100 to be pulled away from the sheath 200 using a normal grip for the continued use of the shears 100.

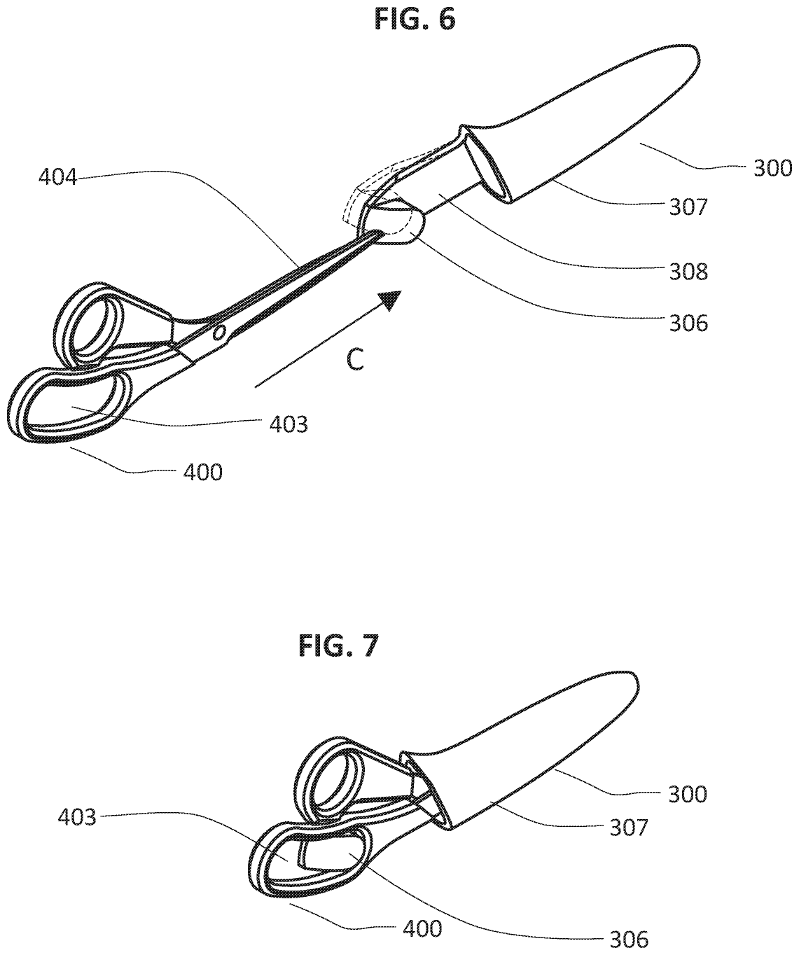

FIGS. 6 and 7 depict illustrations of an alternative design for the sheath 300 and the shears 400, in accordance with one embodiment of the present invention. In the depicted embodiment, the sheath 300 has a single protrusion 306, which is designed to fit within one of the openings of the shears 400. The cover 307 also is designed to substantially cover the blades 404 of the shears 400. The method of inserting the shears 400, does not require inserting and rotating the shears 400, but merely inserting the shears 400 directing into the cover 307, and the protrusion 306 latches into the opening 403.

The configuration of the invention is determined largely by the geometry of the shears that are to be held and includes at least one protrusion that is positioned to correspond to the opening in the handle of the shears. These protrusions are used to latch the shears into the device. A sheath holds the blades of the shears and is connected to the protrusion(s) by a spring plate that can be deflected to allow the protrusion(s) to bypass the shears as they are inserted or removed.

FIG. 6 illustrates an alternate embodiment of the sheath 300 that is suited to an alternate geometry of shears 400. In this embodiment, the user inserts the blades 404 of the shears 400 into the cover 307 with a linear action as depicted by arrow C. In this instance, the blades 404 are fully constrained by the cover 307 and in such an instance only one protrusion 306 is needed to latch into the opening 403. The spring plate 308 may be extended to the nominal width of the shears 400 to prevent relative rotation and improve protection of the shears. In additional embodiments, an additional protrusion may be added and correspond with the other opening of the shears 400.

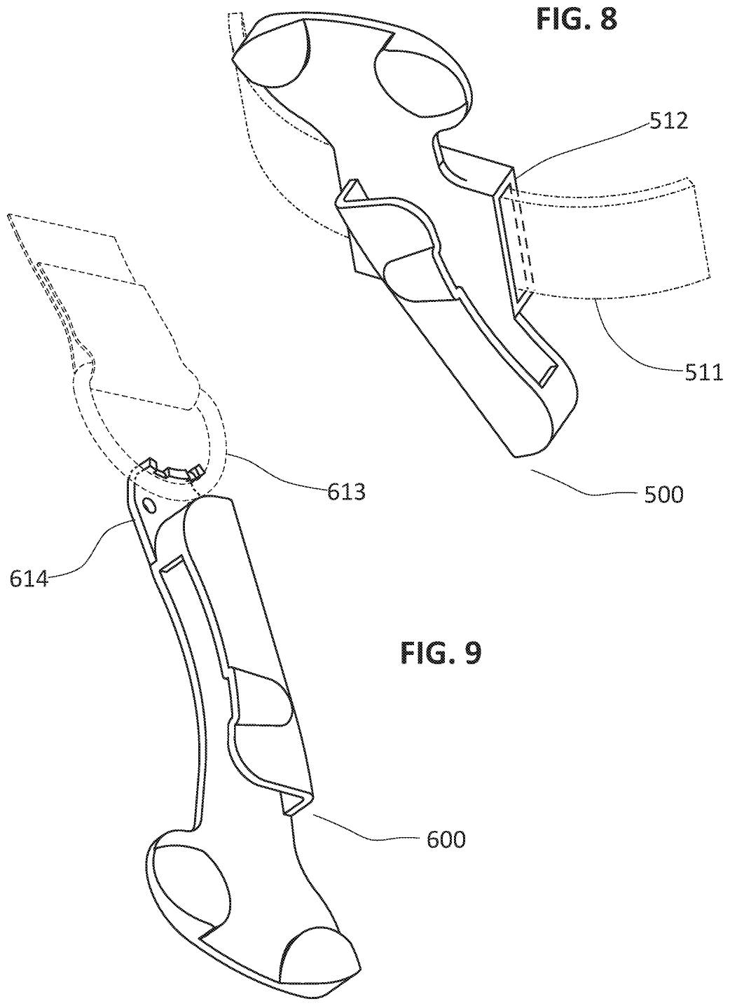

FIG. 8 depicts an illustration of a sheath 500, in accordance with another embodiment of the present invention. In the depicted embodiment, the sheath 500 is shown with an opening 512 designed to be received by various articles of clothing 511 (e.g. belt or strap) to be secured to the user's person. In some embodiments, the opening 512 may be integrated into the black plate of the sheath 500. In other embodiments, the belt attachment may be an additional component which attached to the black plate through various fastening or attachment means known to one skilled in the art. The opening 512 is positioned so that sheath is orientated to be ergonomic for the user.

FIG. 9 depicts an illustration of the sheath 600, in accordance with another embodiment of the present invention. In the depicted embodiment, a bracket 614 is integrated into the back plate of the sheath 600 and has a predetermined attachment mechanism integrated into the bracket 614. For example, the attachment mechanism may be designed to secure to a D-loop 613 that might be found on a rescue harness or SCUBA diving equipment. Such a fitting can include the arrangement for fastening the bracket 614 to the D-loop such as an integrated clip, zip ties, hook and loop straps, screws and other fastening means know to one skilled in the art.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

1. A sheath structure for shears, comprising:
shears having cutting blades and a pair of openings; and
a sheath, which has a first end and a second end, wherein the first end has a cavity, wherein the cavity is sized to receive the cutting blades of the shears and the second end has a restraining means for preventing the shears from releasing from the sheath.

2. The sheath structure for shears of claim 1, wherein the restraining means is at least one protrusion extending from the second end of the sheath, wherein the at least one protrusion is shaped to be received by at least one of the openings of the shears.

3. The sheath structure for shears of claim 2, wherein the second of the sheath is able to deform from a first position to a second position.

4. The sheath structure for shears of claim 2, wherein the at least one protrusions are positioned on the second end of the sheath, so that when the cutting blades are placed within the cavity, the pair of openings align with the at least one protrusion.

5. The sheath structure for shears of claim 1, further comprising a bucket for attaching the sheath to equipment used by a user.

6. The sheath structure for shears of claim 1, further comprising a belt loop portion for attaching the sheath to the belt of a user.

7. A holster for carrying scissors, comprising:
scissors having a pair of handle openings and cutting blades; and
a holster including a first end and a second end, wherein the first end has a cavity, and the cavity has an opening designed to receive the cutting blades of the scissors, and the second end has a set of securing means designed to be received by at least one of the pair of handle openings.

8. The holster for carrying scissors of claim 7, wherein the securing means is at least one protrusion extending from the second end of the holster, wherein the at least one protrusion is shaped to be substantially similar to at least one of the handle openings.

9. The holster for carrying scissors of claim 8, wherein the second of the holster is able to deflect from a first position to a second position, wherein the second position provide access remove the scissors from the holster.

10. The holster for carrying scissors of claim 9, wherein the at least one protrusions are positioned on the second end of the sheath, so that when the cutting blades are placed within the cavity, the pair of handle openings align with the at least one protrusion.

11. The holster for carrying scissors of claim 7, further comprising a bucket for attaching the sheath to equipment used by a user.

12. The holster for carrying scissors of claim 7, further comprising a belt loop portion for attaching the sheath to the belt of a user.

13. A holster for carrying shears, comprising:
a holster, wherein the holster has a first end and a second end, the first end has a compartment designed to receive a cutting end of a pair of shears, and the second end has at least one protrusion designed to secure the pair of shears in place when the cutting end of the pair of shears are placed within the compartment.

14. The holster for carrying shears, of claim 13, wherein the protrusion is sized and shaped to substantially fill an opening formed by a finger insert of the shears.

15. The holster for carrying shears, of claim 13, wherein the second end of the holster is flexible, and is able to deform from a first position to a second position.

16. The holster for carrying shears, of claim 15, wherein the first position is a locked position and the second position is a release position, wherein the shears are removable when the holster is in the second position.

17. The holster for carrying shears, of claim 13, wherein the compartment substantially covers the cutting end of the pair of shears.

18. The holster for carrying shears, of claim 13, wherein the holster is a unitarily constructed component.
